(19) United States
(12) Patent Application Publication
(10) Pub. No.: US 2021/0404799 A1
(43) Pub. Date: Dec. 30, 2021

(54) INSPECTION VEHICLE

(71) Applicant: ECOsubsea AS, Bekkjarvik (NO)

(72) Inventors: Tor Mikal Østervold, Bekkjarvik (NO); Klaus Østervold, Bekkjarvik (NO)

(73) Assignee: ECOsubsea AS, Bekkjarvik (NO)

(21) Appl. No.: 17/471,231

(22) Filed: Sep. 10, 2021

Related U.S. Application Data
(63) Continuation of application No. 15/430,056, filed on Feb. 10, 2017.

(51) Int. Cl. G01B 17/02; B60B 19/00; G01N 17/04; G01B 7/06; B62D 57/04

(52) U.S. Cl. CPC G01B 17/02; B60B 19/006; G03B 17/08; G01B 7/06; B62D 57/04; G01N 17/04

(57) ABSTRACT

Inspection vehicle for under water inspection of coating, marine growth, structural integrity and corrosion on ferromagnetic ship hulls and other ferromagnetic structures. The inspection vehicle is distinctive in that it comprises
a non-magnetic element,
at least one magnetic wheel or device operatively arranged to the element, and
a watertight camera for visual inspection attached to the element or other structure of the inspection vehicle,
wherein the inspection vehicle comprises
one coupling side where the at least one magnetic wheel or device is operatively arranged for the inspection vehicle to couple magnetically through coating, any marine growth and corrosion products and allow rolling the inspection vehicle on said structure, in horizontal to vertical to upside down-orientation while holding the inspection vehicle attached to the structure, and
one non-coupling side oriented in substance in opposite direction to the coupling side, where the at least one magnetic wheel is not operatively arranged and the non-coupling side will not couple magnetically to said structure. A method for operating the inspection vehicle is also provided.

### CROSS-REFERENCE TO RELATED APPLICATIONS

This application is a continuation of U.S. patent application Ser. No. 15/430,056, filed on Feb. 10, 2017. The entire contents of U.S. application Ser. No. 15/430,056 are incorporated by reference in their entirety herein for all purposes.

### FIELD OF THE INVENTION

The present invention relates to inspection of ship hulls and other structure. More specifically, the invention relates to inspection vehicle for under water inspection of coating, marine growth, structural integrity and corrosion on ferromagnetic ship hulls and other ferromagnetic structures.

### BACKGROUND OF THE INVENTION AND PRIOR ART

Coating protects ship hulls and other structures at sea and on shore. Deterioration of the coating on a structure enhances corrosion, which eventually deteriorates the structural integrity. Experience show that new coating systems, after tin was removed as a component from anti-foulings in 2008, are less effective, which may be a result of less effective but also less poisonous and health threatening antifouling agents or additives in recent years, since many substances and compositions have been prohibited or restricted.

Marine growth has a surprising large effect on fuel consumption of a ship. The friction of the hull increases with increasing extent of marine growth. The IMO (International Maritime Organization), a UN (United Nations) organization, indicates that 5-15% of fuel can be saved by having a clean ship hull (Second GHG study 2009, section A2. 63). Other estimates indicate 15%, 20% or 18% (over 60 months) savings, as estimated by Marintek, Propulsion Dynamic (tankers) and Jotun, respectively. In CASPER: The leading edge in vessel performance—Propulsion Dynamics, a saving of 10-20% is estimated.

The quality of the coating, the extent of corrosion and marine growth, and the effects thereof on structural integrity, and structural damages, can in principle be detected and more or less be quantified by visual inspection. Additional sensors and measurements may verify and quantify the findings. However, for a structure such as the hull of a ship at quay, the hull is apparently clean close to or at the waterline, since in many situations, no damages or changes can be identified by a simple visual control from sea level since the damages can be located at deeper level on the hull, not visible in a harbor with seawater of low visibility.

Typically, divers or ROVs (Remotely Operated Vehicles) must be hired in order to undertake a visual control, and in most harbors the service is not readily available. Equipment for inspection exists, but will often require an expert crew, electric power, a control container and often an additional vessel. The equipment is typically advanced, requiring experts for operation and interpretation of the results.

A demand exists for an inspection tool easier to mobilize, which in practice will be used more frequently. A particular demand exist for equipment that is so light, compact and fast to operate that one or two operators alone can inspect ships when in harbor, such as when the ship is at quay, without delaying the period of stay. The objective of the present invention is to meet said demands.

### SUMMARY OF THE INVENTION

The invention provides an inspection vehicle for under water inspection of coating, marine growth, structural integrity and corrosion on ferromagnetic ship hulls and other ferromagnetic structures, above or below water. The inspection vehicle is distinguished in that it comprises:
a non-magnetic element,
at least one magnetic wheel or magnetic device operatively arranged to the element, and
a watertight camera for visual inspection attached to the element or other structure of the inspection vehicle,
wherein the inspection vehicle comprises
one coupling side where the at least one magnetic wheel or device is operatively arranged for the inspection vehicle to couple magnetically through coating, any marine growth and corrosion products and allow rolling the inspection vehicle on said structure, in horizontal to vertical to upside down-orientation while holding the inspection vehicle attached to the structure,
one non-coupling side oriented in substance in opposite direction to the coupling side, where the at least one magnetic wheel or device is not operatively arranged and the non-coupling side will not couple magnetically to said structure, and
optional sensors and devices as specified in dependent claims and/or in the description to follow.

Preferably, the non-magnetic element is single concave or double concave.

Preferably, the magnetic wheel or magnetic device is a magnetic wheel, as discussed and specified in detail below. However, as an alternative or in addition, also magnetic devices being not a wheel per se but being arranged so as to couple magnetically, can be included. For example, the device is a magnet, not rotating but arranged between or medially at the side of non-magnetic wheel with a lift off from the surface being inspected of for example 2-3 mm. Such magnetic devices are preferably electromagnets or permanents magnets for which the magnetism can be turned off, as discussed below.

Preferably, the inspection vehicle comprises at least two magnetic wheels arranged apart to the non-magnetic element . The inspection vehicle may comprise one, two, three or more non-magnetic wheels, the number of magnetic wheels can be increased if required, by replacing non-magnetic wheels.

Preferably, the non-magnetic element is one of:
a concave shell structure,
a concave shell structure that is in substance circular,
a concave shell structure that is in substance elongated,
a concave shell structure that is in substance circular or elongated, wherein the magnetic wheels are encompassed by said shell structure, the wheels extending out from the shell structure only on a coupling side, being an underside of the inspection vehicle to face and attach to the inspected structure during operation, preferably said shell structure also extends laterally around at least the magnetic wheels,
a curved beam with the concave side to face outwards from the inspected structure during inspection,
a curved beam with the concave side to face outwards from the inspected structure during operation, wherein the beam is one of elongated and equidistant with respect to length and width, preferably said curved beam also extends laterally around at least the magnetic wheels,
a curved truss-structure with the concave side to face outwards from the inspected structure during operation,
a curved truss-structure with the concave side to face upwards from the inspected structure during operation, wherein the curved truss structure is one of elongated and equidistant with respect to length and width, preferably said curved truss-structure also extends laterally around at least the magnetic wheels,
a concave shell structure, beam structure or truss structure,
a concave shell structure, beam structure or truss structure, encompassing at least the magnetic wheels , and having curvature or concavity so that when the inspection vehicle hangs along a vertical ship hull side the center of gravity is at elevation below a midpoint between the at least two axially apart wheels, preferably the lower elevation wheels are larger in number and/or weight than the higher elevation wheel when the inspection vehicle hangs along a vertical ship hull.

Preferably, the inspection vehicle comprises a watertight camera with live-feed functionality. All cameras, sensors, lights and devices operatively arranged to or integrated into the inspection vehicle of the invention are watertight at least down to the depth elevation for intended operation.

Preferably, the inspection vehicle comprises one or more of, in any combination:
a sensor for measuring coating and marine growth thickness, preferably the sensor is an inductance based sensor,
a sensor for measuring the thickness of a hull or other structure being inspected, such as a tank wall thickness, a pipe wall thickness or a vessel hull thickness, preferably the sensor is an ultrasound based sensor,
a means for placing out sensors or other equipment, such as a solenoid-operated release mechanism holding the sensor or equipment until a release position is reached,
a light, and
a combination of an induction based sensor, such as an eddy current sensor, and an ultrasound-based sensor, which combination measures lift-off from the ferromagnetic structure being inspected, coating thickness, marine growth thickness and type and ferromagnetic structure wall or hull thickness.

Preferably, the sensor or sensors are spring-loaded sensor integrated in a concave structure arranged to slide on the structure to be inspected, or is arranged into a wheel or arranged to or into a shaft between wheels. Alternatively, some or all sensors of the inspection vehicle are arranged at a distance from the structure to be inspected, preferably a known and fixed distance.

The lift-off from the ferromagnetic structure being inspected, is the sum of coating thickness and marine growth thickness and optional corrosion, said lift-off can be measured precisely with an inductance based sensor, such as an eddy current sensor. By using an ultrasound based sensor, sometimes called ultrasound probe or UT probe, and knowing the precise lift-off; coating thickness, marine growth thickness, corrosion, coating quality and type of marine growth can be determined based on differences in ultrasound velocity and reflexes. Preferably, a multi-source ultrasound probe is used, similar to the probes used for medical purposes, since the resolution and detail level is higher than for ultrasound probes used traditionally in non-destructive testing and examination.

The inspection vehicle preferably comprises a rope or a combined rope and cable in an upper end of the vehicle as seen when the vehicle hangs along a vertical ship hull side, preferably a rope or line combining handling and communication and preferably also power and control, as a bundle or a single umbilical.

The inspection vehicle preferably comprises wheels with a drive mechanism, preferably electric drive and a battery integrated in or power via a cable attached to the inspection vehicle, preferably including a steering function, such as steerable wheels or a steerable hinge on the inspection vehicle, and preferably a device for steering, such as a joystick. Waterproof drive and control mechanisms of radio or cable controlled cars or vehicles are possible features of such embodiments.

The inspection vehicle preferably comprises wheels and/or structure that are wider and/or heavier in a lower end of the inspection vehicle than in an upper end of the inspection vehicle, as seen with the inspection vehicle hanging along and attached to a vertical hull side. This provides easier lowering and orientation.

The inspection vehicle preferably comprises a position or motion sensor, such as a gyro sensor and/or accelerometers, preferably also a GPS sensor, and associated software either in the inspection vehicle or in a control computer or similar operatively connected by cable or wireless, or writing to a storage, arranged to document the position and motions at all time during an inspection run.

The inspection vehicle preferably weights less than 25 kg and having no dimension larger than 1 m as packed in an operations container, to allow transport, handling and operation by one single operator. Preferably, the vehicle weights about 5 to 25 kg, preferably about 10 kg in air and about 3 to 20 kg, preferably about 7 kg in water. The magnetic wheels per se, in one embodiment, have about 155 kg magnetic coupling force on the flat side (without paint on the hull) and having a diameter of about 0.1 m and a wheel width of about 1.5 cm. A typical inspection vehicle of the invention is about 50 cm long, 20 cm wide and about 20 cm high.

However, the inspection vehicle preferably is designed so that the wheels never can couple to the structure with the flat side, by the magnetic wheels comprising a lateral protrusion and/or by arranging magnetic wheels between non-magnetic wheels. The protrusion are for example half-ball-shaped rubber structures, preventing the inspection vehicle to tip over lying flat with one, two or more magnetic wheels fastened hard to the hull. However, most preferably the non-magnetic element has shape preventing magnetic coupling laterally to the at least one magnetic wheel, by having the non-coupling side structure designed to cover and mask said wheel or wheels laterally but no towards the coupling side.

The invention also provides a method for under water inspection of coating, marine growth, structural integrity and corrosion on ferromagnetic ship hulls and other ferromagnetic structures, using an inspection vehicle according to the invention. The method is distinctive by comprising the steps:
to start recording with the camera,
to lower the inspection vehicle down the inspected structure and below the surface, while the inspection vehicle hangs in a rope/cable, by letting out rope/cable, until the desired depth or position has been reached, optionally also inspecting during the length of run along the structure or at predetermined positions for one or more of: coating thickness, marine growth, structural integrity, structure wall thickness and corrosion; and optionally to adjust the magnetic coupling force according to inspection vehicle position and orientation, and to repeat the steps at desired positions for inspection.

Preferably, video footage is recorder by the camera, the rope/cable comprises distance marks, which distance marks are used for depth control, or using depth gauge, digital or manual, optionally sensors integrated in the inspection vehicle.

Preferably, a line/cable can be or is attached in either end of the inspection vehicle, the lines are used to keel-draw the inspection vehicle around the hull at desired positions.

The invention also provides application or use of the inspection vehicle of the invention, for providing information for deciding to clean a ship hull sufficiently often to provide a fuel saving of typical up to 5-20% and resulting corresponding reduced emission of greenhouse gases (GHG).

The above definition of the inspection vehicle implies that the non-magnetic element is made of a non-magnetic material so as not to attach magnetically to a ferromagnetic structure per se or as assembled with the magnetic wheels as part of the inspection vehicle.

Non-magnetic material, in the context of non-magnetic element, means non-magnetized material, per se or as assembled with the magnetic wheels as part of the inspection vehicle. Accordingly, the non-magnetic element can be made of carbon steel or other ferromagnetic material so long as it cannot be magnetized to couple to the ferromagnetic structure to be inspected as operatively integrated in the inspection vehicle.

In principle, the inspection vehicle of the invention comprises only one coupling side, which means only one side coupling magnetically to the structure to be inspected. Depending on the design, the inspection vehicle comprises 1, 2, 3, 4 or 5 non-coupling sides, meaning sides not coupling magnetically to the structure to be inspected. A design where the inspection vehicle has shape in substance as a cube or elongated cube comprises 5 non-coupling sides. A design where the inspection vehicle has shape in substance as a double concave shell or shell-like structure over the coupling side, has only one non-coupling side. Intermediate shapes in between cube-like shape and double concave shell-like shape gives 2-4 non-coupling sides, all such shapes represents embodiments of the inspection vehicle of the invention. One example is an inspection vehicle with two or three concave and/or double concave non-coupling sides and one coupling side.

Inspection of ship hulls under water implies that the ship is at quay or other location floating on water, contrary to laying out of service in a dry dock. The term magnetic wheels means permanent magnet wheels or electromagnetic wheels. A permanent magnet wheel is a wheel comprising permanent magnetic material, the resulting magnetism is permanent or can be turned on and off, preferably the magnetism can be turned on and off, at the wheel or through a cable connected to the inspection vehicle. An electromagnetic wheel comprises an electromagnet, the magnetism can be turned on and off by turning an electric current through the electromagnet on and off. The inspection vehicle comprises 1, 2, 3 or 4 or more magnetic wheels. The magnetic wheels can be permanent magnet wheels, electromagnetic magnet wheels or any combinations of permanent magnet wheels and electromagnetic wheels.

The magnetic coupling, provided with the magnetic wheels, provides a magnetic coupling force attaching and holding the inspection vehicle to the structure being inspected.

For inspection under water or immersed in other liquid, the magnetic coupling force is preferably in a range from 0.5 to 2 times, more preferably 1 to 1.5 times, such as 1.3 times the weight of the inspection vehicle as immersed.

For inspection above water, in air or other gas, the magnetic coupling force is preferably in a range from 0.5 to 2 times, more preferably 1 to 1.5 times, such as 1.3 times the weight of the inspection vehicle in air.

For inspection in upside-down positions, the holding force must be above 1 times the weight of the inspection vehicle at the actual position, be it under water or above water. For inspection in vertical and horizontal positions, the holding force can be below 1 times the weight of the inspection vehicle at the actual position, be it under water or above water.

Preferably, the magnetic coupling and the resulting magnetic coupling force is adjustable. Adjustment for electromagnetic wheels are by adjusting the electric current from 0 and 0 coupling force up to a maximum coupling force exceeding the weight of the inspection vehicle in the actual position, be it under water or above water. Adjustment for permanent magnet wheels are by manipulating the wheels mechanically, on the inspection vehicle or through an electric cable, using a solenoid switch or mechanic switch or a similar device, between on and off and preferably with one or more coupling force steps in between.

The inspection vehicle preferably comprises a rope or line combining handling and communication, and preferably also power and control, as a bundle or single rope or line or umbilical.

Preferably, the coupling side of the inspection vehicle is convex.

Preferably, the coupling side of the inspection vehicle is convex and the non-coupling side is concave.

The camera is a film camera or a still picture camera, or a camera shooting both still pictures and film. The camera can be started when lowering of the inspection vehicle starts, or the camera can be remotely controlled. The camera preferably comprises a battery, requiring no external power. Alternatively, the camera, and preferably also sensors and light, are powered and/or controlled by cable, integrated into or fastened to the cable used for lowering the vehicle. Preferably, the camera is a commercially available film camera arranged into or comprising a watertight housing. The camera distance from the object is preferably equal to or larger than the minimum focus distance of the camera, for example 20 cm.

The inspection vehicle preferably comprises lugs or ears for fastening of ropes, lines or similar in either end.

The magnetic wheels are for example 0.05-0.15 m in diameter. Double or treble magnetic wheels can be mounted on the vehicle if required for sufficiently strong magnetic coupling to the hull, for example if a hull surface has many thick layers of paint and/or extensive marine growth.

Testing has verified that the above parameters are feasible for having an operable inspection vehicle that will attach to and roll over the hull even if severe marine growth is encountered. The inspection vehicle will move over obstacles, be it soft or hard marine growth or details on the hull, and allow increased lift off from the hull plates due to layers of marine growth, while still attaching to the hull. The curvature of concave and convex surfaces can easily be followed. For many embodiments, no external power supply is needed. The inspection vehicle can easily be transported in a case by one person and be operated by one person, providing swift mobilization and use and providing the results live or immediately after operation. The ropes, wires or lines attached to the vehicle should be strong enough to draw loose the vehicle in any foreseeable situation.

### FIGURE

The inspection vehicle of the invention is illustrated by 7 figures, namely

FIGS. 1A and 1B, illustrating one of many possible embodiments of an inspection vehicle of the invention, as seen from the side and from above, respectively,

FIG. 2 illustrating another embodiment of the inspection vehicle of the invention,

FIG. 3 illustrating a further embodiment of an inspection vehicle of the invention, as hanging down a ship hull side,

FIGS. 4 and 5 illustrate an embodiment of magnetic wheels, and

FIGS. 6 and 7 illustrate an embodiment of magnetic devices.

### DETAILED DESCRIPTION

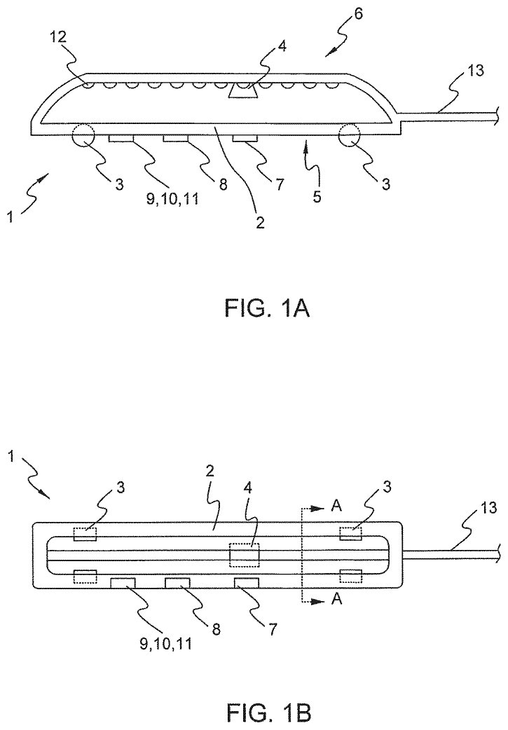

Reference is made to FIGS. 1A and 1B, illustrating an inspection vehicle of the invention, as seen from the side and from above, respectively. More specifically, the inspection vehicle (1) for under water inspection of coating, marine growth, structural integrity and corrosion on ferromagnetic ship hulls and other ferromagnetic structures, above and below water comprises a non-magnetic element (2), at least one magnetic wheel (3) operatively arranged to the element, and a watertight camera (4) for visual inspection attached to the element or other structure of the inspection vehicle. The inspection vehicle further comprises one coupling side (5) where the at least one magnetic wheel is operatively arranged for the inspection vehicle to couple magnetically and allow rolling the inspection vehicle on said structure, through coating, marine growth and corrosion, in horizontal to vertical to upside down-orientation while holding the inspection vehicle attached to the structure; and one non-coupling side (6) oriented in substance in opposite direction to the coupling side, where the at least one magnetic wheel is not operatively arranged and the non-coupling side will not couple magnetically to said structure. The inspection vehicle also comprises sensors 7,8 and means 9 for placing out and retrieving sensors or other equipment, position or motion sensor 10, GPS sensor 11, light 12, for example a LED light rail, and a rope 13 for combined handling/lowering, power, control and communication.

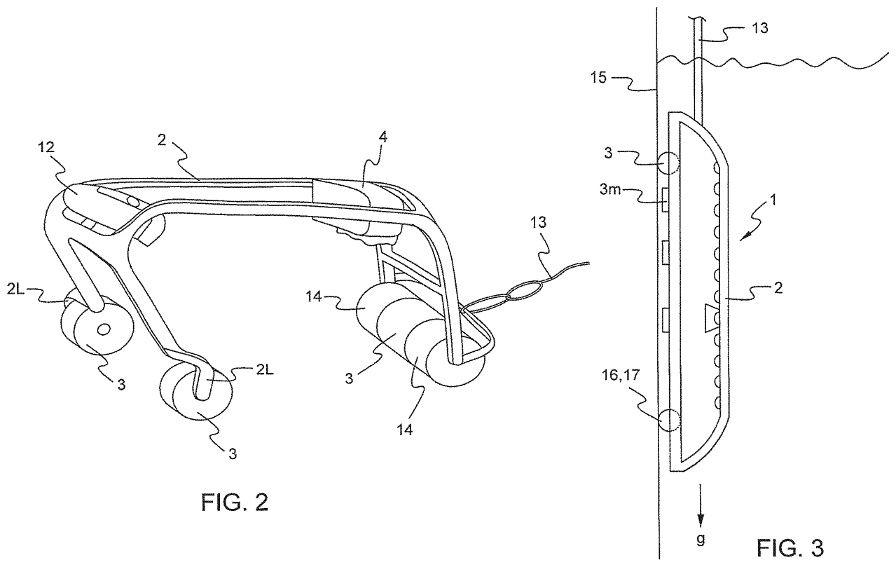

FIG. 2 illustrates a further embodiment of an inspection vehicle 1 of the invention, wherein the non-magnetic element 2 is a concave beam structure. In a lower end, as seen when hanging down a ship hull side, two magnetic wheels 3 are laterally protected from attaching to the structure to be inspected by structure 2L of the non-magnetic element 2. The concavity or curvature of the non-magnetic element is “inclined downwards”, which provides a center of gravity closer to the lower end than the upper end when the inspection vehicle hangs from a rope 13 in the upper end. The height of the illustrated inspection vehicle is not to scale but is exaggerated, to see the details thereof clearer. In the upper end a magnetic wheel 3 is arranged in between non-magnetic wheels 14, preventing lateral coupling by the magnetic wheel 3 in between.

FIG. 3 illustrates a further embodiment of the inspection vehicle 1 and the method of the invention. More specifically, the further inspection vehicle 1 embodiment comprises a shell-like concave structure as non-magnetic element 2 and the inspection vehicle is illustrated as rolling down a ship hull side 15, lowered with a rope or line 13, helped by gravity g. A drive mechanism 16, and optionally a steering mechanism 17, can be included, and will help in deploying the inspection vehicle further under the hull towards and optionally beyond the keel. A magnetic device 3m is illustrated.

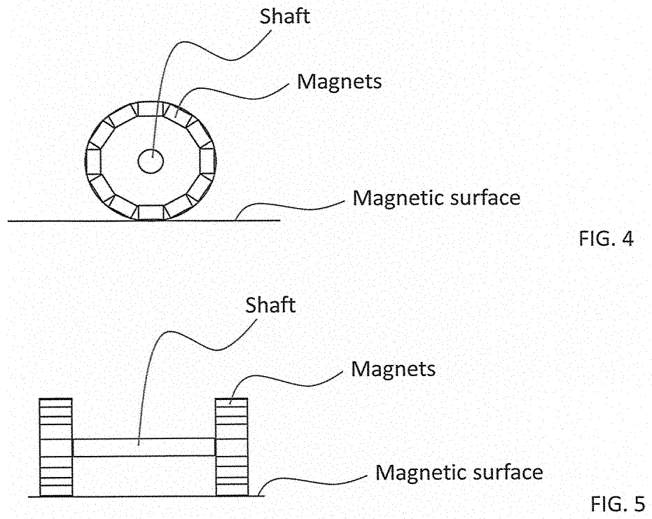

FIGS. 4 and 5 illustrate an embodiment of magnetic wheels, more specifically as seen from the side and from a front position. Pieces of permanent magnets are arranged regularly along the periphery of otherwise non-magnetic wheels. The permanent magnet pieces extend as far out in radial direction of the wheel as non-magnetic parts, which improves wear resistance. Alternatively, the magnetic pieces extend 0-3 mm less in radial direction than the non-magnetic parts of the wheel.

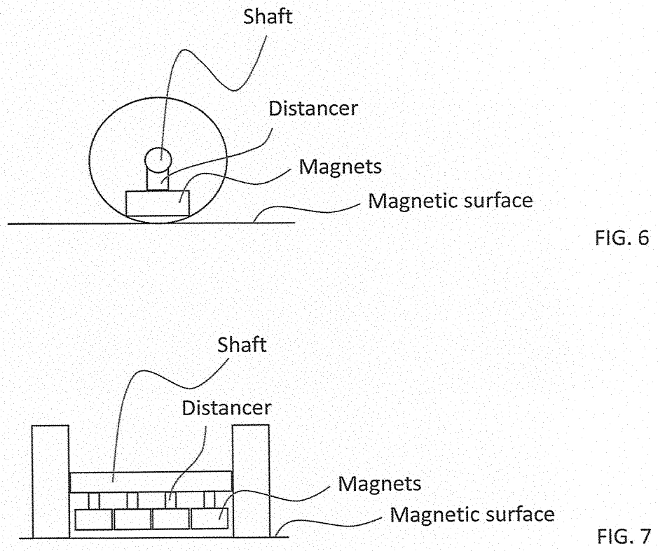

FIGS. 6 and 7 illustrate an embodiment of magnetic devices, as seen from the side and from a front position. The magnetic devices are preferably non-rotatable permanent magnet pieces, they are easy to take in our out for adjusting magnetic coupling force or cleaning for any magnetic debris. Magnetic coupling force is adjusted by adjusting the number and/or type of magnetic devices used in the inspection vehicle.

Double magnet wheels, or even triple magnet wheels, and/or magnetic wheels with adjustable magnetic coupling force, can be used if increased magnetic coupling is required.

The invention provides an inspection vehicle for under water inspection of ship hulls and other ferromagnetic structures, but also non-ferromagnetic structures that are orientated upwards from gravity, allowing inspection even without magnetic coupling.

The inspection vehicle is distinctive in that it merely may consists of a non-magnetic element, at least one magnetic wheel arranged operatively to said element, and a watertight camera for visual inspection of coating, marine growth, structural integrity and corrosion of the structure being inspected, in addition to optional sensors and light. The inspection vehicle has a size and weight making it easy for one person to operate and transport the inspection vehicle. Said non-magnetic element is preferably convex or double convex, at an extent making it impossible for the inspection vehicle of the invention to attach itself to a ship hull or other ferromagnetic structure to be inspected when at upside-down orientation or sideways orientation relative to the hull or structure to be inspected. In contrast to the comprehensive prior art systems, requiring a team of personnel and typically a container full of equipment, only one or two persons are required for operation.

The inspection vehicle of the invention and the method of the invention provide an easier and more cost effective way of deciding inter alia the existence and extent of marine growth on a hull, and whether or not to remove said growth. One person can operate the inspection vehicle when a ship is at a harbor in ordinary operation. The invention has a significant positive effect on the environment, since convenient removal of marine growth reduces fuel consumption of ships significantly.

The inspection vehicle of the invention can have numerous embodiments, including any combination of features here described or illustrated. The method of the invention can include any feature or step as here described or illustrated, in any operative combination.

1. An inspection vehicle for underwater inspection of a ferromagnetic structure, the inspection vehicle comprising:
a non-magnetic element;
at least one of a magnetic wheel and magnetic device operatively arranged to the non-magnetic element;
a watertight camera for visual inspection attached to the non-magnetic element or other structure of the inspection vehicle;
a coupling side where at least one of the magnetic wheel and the magnetic device is operatively arranged for the inspection vehicle to couple magnetically in an underwater environment through a coating, any marine growth, and corrosion products and allow rolling of the inspection vehicle on the ferromagnetic structure, in a horizontal to vertical to upside down-orientation while holding the inspection vehicle attached to the ferromagnetic structure, wherein the structure of the at least one of a magnetic wheel and magnetic device is the only structure securing the attachment of the inspection vehicle in position in vertical to upside down orientation;
a non-coupling side oriented in substance in opposite direction to the coupling side;
a combination of an inductance-based sensor and an ultrasound-based sensor,
wherein exact lift-off, that is the combined coating thickness and marine growth thickness, is measured by using the inductance-based sensor only, wherein the inductance-based sensor is configured to measure the lift-off exactly, irrespective of and unaffected by the type of marine growth or the condition of the coating; and,
wherein the type of marine growth is found by measuring coating thickness by the ultrasound-based sensor; wherein the properties of the unknown marine growth affect the ultrasound velocity and reflections, but since the exact thickness of the marine growth can be determined by subtracting the coating thickness from the lift off, said affected properties can be correlated to determine the type of marine growth when the thickness of the marine growth is known;
a connector end, where a rope or line for lowering and lifting the inspection vehicle, and lines for power and control, are connected, as a bundle or a single line or umbilical, wherein the lowering is controlled by gravity and letting out of the rope or line;
at least two axially apart wheels, wherein the axially apart wheels remote from the connector end are larger in at least one of number and weight than wheels near the connector end, providing a center of gravity closer to an end remote from the connector end of the inspection vehicle; and
wherein the inspection vehicle weighs less than 25 kg and has no dimension larger than 1 m as packed in an operations container, allowing transport, handling, and operation by one single operator.

2. The inspection vehicle according to claim 1, comprising one or more of the features:
wherein the non-magnetic element is at least one of single and double concave;
a concave shell structure, beam structure or truss structure having curvature or concavity so that when the inspection vehicle hangs along a vertical ship hull side, the center of gravity is at an elevation below a midpoint between at least two magnetic wheels at differing elevations;
a solenoid-operated release mechanism for placing out sensors or other equipment;
a light;
a wheel with a drive mechanism;
a position or motion sensor and associated software arranged to document position and motions at all times during an inspection run, and
wherein one or more of corrosion, coating quality, and ferromagnetic structure wall or hull thickness are measured with the ultrasound-based sensor.

3. A method for underwater inspection of a ferromagnetic structure using an inspection vehicle according to claim 1, the method comprising:
starting recording with the watertight camera;
lowering the inspection vehicle down to the ferromagnetic structure and below the surface, while the inspection vehicle hangs in a rope/cable, by letting out the rope/cable, until a desired depth or position has been reached, whereby the inspection vehicle is held and rolled on the ferromagnetic structure in positions from horizontal to vertical to upside down,
wherein the structure of the coupling side attaching the inspection vehicle in vertical to upside down-orientation to the ferromagnetic structure consists of magnetic wheels and magnetic devices, and wherein the lowering is controlled by gravity and a letting out of the rope or cable;
wherein a combination of an inductance-based sensor and an ultrasound-based sensor is utilized, wherein lift-off is measured with the inductance-based sensor, while the ultrasound-based sensor, when knowing the lift-off as measured by the inductance-based sensor, measures coating thickness, wherein the properties of the unknown marine growth affect the ultrasound velocity and reflections, but since the exact thickness of the marine growth thereby can be determined, said affected properties can be correlated to determine the type of marine growth;
wherein the inspection vehicle weighs less than 25 kg and has no dimension larger than 1 m as packed in an operations container, allowing transport, handling, and operation by one single operator; and
repeating the steps above at desired positions for inspection.

4. Method according to claim 3, wherein an arrangement of the axially apart wheels remote from the connector end are larger in at least one of number and weight than wheels near the connector end, providing a center of gravity closer to an end remote from the connector end of the inspection vehicle, wherein stability of tracking of the inspection vehicle is facilitated.

5. The method according to claim 3, comprising adjusting the magnetic coupling force.

6. The method according to claim 3, wherein:
the ferromagnetic structure being inspected is at least one of a tank wall thickness, a pipe wall thickness, and a vessel hull thickness, and further parameters measured are at least one of corrosion, coating quality and ferromagnetic structure wall or hull thickness;

7. The inspection vehicle according to claim 1, wherein a concave shell structure, beam structure, or truss structure encompasses the at least one magnetic wheel.

8. An inspection vehicle for underwater inspection of a ferromagnetic structure, the inspection vehicle comprising:
a non-magnetic element;
at least one of a magnetic wheel and magnetic device operatively arranged to the non-magnetic element;
a watertight camera for visual inspection attached to the non-magnetic element or other structure of the inspection vehicle;
a coupling side where at least one of the magnetic wheel and the magnetic device is operatively arranged for the inspection vehicle to couple magnetically in an underwater environment through a coating, any marine growth, and corrosion products and allow rolling of the inspection vehicle on the ferromagnetic structure, in a horizontal to vertical to upside down-orientation while holding the inspection vehicle attached to the ferromagnetic structure, wherein the structure of the at least one of a magnetic wheel and magnetic device is the only structure securing the attachment of the inspection vehicle in position in vertical to upside down-orientation;
a non-coupling side oriented in substance in opposite direction to the coupling side;
a connector end, where a rope or line for lowering and lifting the inspection vehicle, and lines for power and control, are connected, as a bundle or a single line or umbilical, wherein the lowering is controlled by gravity and a letting out of the rope or line;
at least two axially apart wheels, wherein the two axially apart wheels remote from the connector end are larger in at least one of number and weight than wheels near the connector end, providing a center of gravity closer to an end remote from the connector end of the inspection vehicle; and
wherein the inspection vehicle weighs less than 25 kg and has no dimension larger than 1 m as packed in an operations container, allowing transport, handling, and operation by one single operator.

9. The inspection vehicle according to claim 8, comprising a combination of an inductance-based sensor and an ultrasound-based sensor, wherein lift-off is measured with the inductance-based sensor and coating thickness is measured with the ultrasound-based sensor, and when thereby determining the marine growth thickness, type of marine growth is determined based on differences in ultrasound velocity and reflexes.

10. The inspection vehicle of claim 9, wherein one or more of corrosion, coating quality, and ferromagnetic structure wall or hull thickness are measured with the ultrasound based sensor.

11. An inspection vehicle for underwater inspection of a ferromagnetic structure, the inspection vehicle comprising:
a non-magnetic element;
at least one of a magnetic wheel and magnetic device operatively arranged to the non-magnetic element;
a watertight camera for visual inspection attached to the non-magnetic element or other structure of the inspection vehicle;
a coupling side where at least one of the magnetic wheel and the magnetic device is operatively arranged for the inspection vehicle to couple magnetically in an underwater environment through a coating, any marine growth, and corrosion products and allow rolling of the inspection vehicle on the ferromagnetic structure, in a horizontal to vertical to upside down-orientation while holding the inspection vehicle attached to the ferromagnetic structure;
a non-coupling side oriented in substance in opposite direction to the coupling side;
a combination of an inductance-based sensor and an ultrasound-based sensor, wherein exact lift-off, that is the combined coating thickness and marine growth thickness, is measured with the inductance-based sensor, unaffected by the type of marine growth or the condition of the coating, while the ultrasound-based sensor, when knowing the exact lift-off as measured independently by the inductance-based sensor, measures coating thickness, wherein properties of the unknown type of marine growth can be determined since exact marine growth thickness can be determined by subtracting the coating thickness from the lift off and differences in ultrasound velocity and reflections thereof can be correlated to marine growth type, and,
optionally, also measuring one or more of corrosion, coating quality, and ferromagnetic structure wall or hull thickness with the ultrasound sensor;
further comprising
a connector end, where a rope or line for lowering and lifting the inspection vehicle, and lines for power and control, are connected, as a bundle or a single line or umbilical, wherein the lowering is controlled by gravity and a letting out of the rope or line;
at least two axially apart wheels, wherein the two axially apart wheels remote from the connector end are larger in at least one of number and weight than wheels near the connector end, providing a center of gravity closer to an end remote from the connector end of the inspection vehicle; and
wherein the inspection vehicle weighs less than 25 kg and has no dimension larger than 1 m as packed in an operations container, allowing transport, handling, and operation by one single operator.
